(19) United States
(12) Patent Application Publication
(10) Pub. No.: US 2014/0218889 A1
(43) Pub. Date: Aug. 7, 2014

(54) OPTICAL WAVEGUIDE SHEET FOR KEYPAD

(71) Applicant: MAGMA CO., LTD., Gimpo-si (KR)

(72) Inventor: Young-Kap KWAK, Seoul (KR)

(73) Assignee: MAGMA CO., LTD., Gimpo-si (KR)

(21) Appl. No.: 13/761,688

(22) Filed: Feb. 7, 2013

(51) Int. Cl. H01H 13/83

(52) U.S. Cl. CPC H01H 13/83
USPC 362/23.03

(57) ABSTRACT

Provided is optical waveguide sheet for a keypad having a light guiding portion 21 positioned below an indicating portion 11a of a keytop part 11, and a light introducing portion 22 positioned above a light source 13 to guide the light emitted from the light source 13 to the light guiding portion 21 so as to be guided toward the indicating portion 11a. The light introducing portion 22 includes a through hole 24 formed therein, a light introducing flap 23 of a barrel shape formed around the edge of the through hole 24 so as to connect with the light introducing portion 22 and protrude toward the light source 13, and a light introducing section 23a provided on an end of the light introducing flap 23 for the light emitted from the light source 13 to be introduced.

### BACKGROUND OF THE INVENTION

1. Field of the Invention The present invention relates to an optical waveguide sheet for a keypad, and more specifically, to an optical waveguide sheet for a keypad that guides the light emitted from an internal light source to characters or figures of the keytop part, so as to brightly illuminate the characters or figures provided in a portable terminal of mobile phones, etc. or a keytop part of electronic devices.

2. Description of the Related Art

In general, portable terminals such as mobile phones, etc. or electronic devices have a key button or function indicating portion (hereinafter briefly refer to as “an indicating portion”) for switching control provided in the keytop part, and a keypad and a printed circuit board disposed with a switch device laminated one by one below the keytop. Further, the indicating portion of the keytop part is designed in various patterns such as numerals, characters, or figures. A light source such as an LED is mounted on the printed circuit board to brightly illuminate the indicating portion, and an optical waveguide sheet for guiding the light emitted from the light source to the indicating portion of the keytop part is formed between the keytop part and the keypad.

FIG. 1 is a front view showing a conventional mobile phone. As shown in FIG. 1, a display part 2 and a keytop part 3 are provided on the front, and an indicating portion 3a for indicating the function keys or functions is provided in the keytop part 3.

FIG. 2 is a sectional view taken on line A-A of FIG. 1 for showing the configuration and installation structure of a conventional optical waveguide sheet 4 for a keypad. That is, the optical waveguide sheet 4 is disposed between the keytop part 3 and the keypad 5, and a light guiding portion 4a of the optical waveguide sheet 4 is positioned right below and a light introducing portion 4b is positioned above a light source 6. Accordingly, the light emitted from the light source 6 is guided to the light guiding portion 4a through the light introducing portion 4b of the optical waveguide sheet 4 to be guided toward the indicating portion 3a of the keytop part 3 so as to brightly illuminate the indicating portion 3a.

A reflective tape 7 is attached on the bottom of the light guiding portion 4a of the optical waveguide sheet 4 for more light to be guided toward the indicating portion 3a. Further, a reflective plate 8 is also attached to the top of the light introducing portion 4b of the optical waveguide sheet 4 by a double-sided tape 9 so as to guide more light to the light guiding portion 4a.

The optical waveguide sheet 4 and the light source 6 that are disposed in this way have the light introducing portion 4b and the light source 6 separated from each other at a predetermined interval because of each determined position. Accordingly, in order to increase the efficiency for introduction of light, the interval between the light introducing portion 4b and the light source 6 should be maintained close to the maximum. For this purpose, conventionally a thick reflective plate 8 was attached in lamination to the top of the light introducing portion 4b so as to make the gap between the light introducing portion 4b and the light source 6 closer by that much.

However, the reflective plate 8 is of a kind different from the reflective tape 7 that has an adhesive layer formed thereon, so it is not provided with an adhesive layer. Therefore, many reflective plates 8 were attached to the light introducing portion 4b using double-sided tapes 9. Since attaching them one by one relies on worker's manual labor, it has a problem that the work process is cumbersome and the process time becomes long. Furthermore, because the reflective plate 8 is a very expensive material compared with the reflective tape 7, the cost rises. Conventionally, workability and productivity have been lowered by the attaching process of the reflective plate 8, and the manufacturing cost increased due to the rise of labor costs and materials costs.

### SUMMARY OF THE INVENTION

In consideration of the above-mentioned problems, it is an object of the present invention to provide an optical waveguide sheet for a keypad, whereby the efficiency for introduction of light from the light source can be increased, and the configuration of the light introducing portion can be simplified, so that thick reflective plates or double-sided tapes for attaching the thick plates become unnecessary so as to reduce the cost of high-priced materials, and workability and productivity are improved and the manufacturing cost is lowered by shortening the manufacturing process.

To achieve the above object, there is provided an optical waveguide sheet for a keypad having a light guiding portion positioned below an indicating portion of a keytop part, and a light introducing portion positioned above a light source to guide a light emitted from the light source to the light guiding portion so as to be guided toward the indicating portion, wherein the light introducing portion includes a through hole formed therein, a light introducing flap of a barrel shape formed around the edge of the through hole so as to connect with the light introducing portion and protrude toward the light source, and a light introducing section provided on an end of the light introducing flap for the light emitted from the light source to be introduced.

Preferably, a part of the light introducing section provided on the light introducing flap is disposed so as to face the light source.

Preferably, the through hole has a rectangular or circular cross section.

Preferably, the light guiding portion is provided with a reflective pattern, the through hole of the light introducing portion has a rectangular cross section, and a curved portion for guiding the light toward the reflective pattern of the light guiding portion is formed on one side wall surface of the light introducing flap positioned near to the light guiding portion.

Preferably, the light introducing flap includes a plurality of curved portions for structural reinforcing.

According to the present invention having such a characteristic configuration, the structure can be simplified very much by a light introducing flap of a barrel shape formed around the edge of the through hole so as to connect with the light introducing portion and protrude toward the light source and the light introducing portion can be made closer to the light source, so that the materials cost is reduced as it is not necessary to laminate reflective plates that were used conventionally to position the light introducing portion toward the light source, and the unit cost of manufacturing optical waveguide sheets can be lowered by a great deal as workability and productivity are improved due to the shortening of the manufacturing process.

In addition, according to the present invention, a part of the light introducing section of the light introducing flap is formed so as to face the light source, so the efficiency for introduction of light from the light source can be increased, thereby making it possible to illuminate the indicating portion of the keypad more brightly, so the indicating function can be improved.

Further, according to the present invention, the cross section of the through hole formed in the light introducing portion is rectangular or circular, and the light introducing flap is formed successively along the edge portion of the through hole, so it is possible to maximally suppress from moving the position of the light introducing section, which is an end section of the light introducing flap, and thereby it is possible to maintain to the maximum the performance for introduction of light by the light introducing flap even after the assembly of the optical waveguide sheet.

Further, according to the present invention, the cross section of the through hole formed in the light introducing portion is rectangular, and the curved portion that guides the light toward the reflective pattern of the light guiding portion is formed on the light introducing flap toward the light guiding portion, so the light introduced from the light source can be guided to the reflective pattern in a concentrated manner, thereby improving the efficiency for introduction of light so as to illuminate the indicating portion more brightly.

In addition, according to the present invention, it is possible to further suppress from moving or bending deformation of the light introducing portion by reinforcing the structural strength by a plurality of bent portions formed on the light introducing flap.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view showing a conventional mobile phone;

FIG. 2 is a sectional view taken on line A-A of FIG;

FIG. 3 is a sectional view showing the installation state of an optical waveguide sheet for a keypad according to one embodiment of the present invention;

FIG. 4 is a plan view showing the optical waveguide sheet for a keypad of the present invention;

FIG. 5 is an enlarged view showing another example of a light introducing portion of the optical waveguide sheet for a keypad according to the present invention;

FIG. 6 is an enlarged view showing yet another example of a light introducing portion of the optical waveguide sheet for a keypad according to the present invention; and

FIG. 7 is an enlarged view showing still another example of a light introducing portion of the optical waveguide sheet for a keypad according to the present invention.

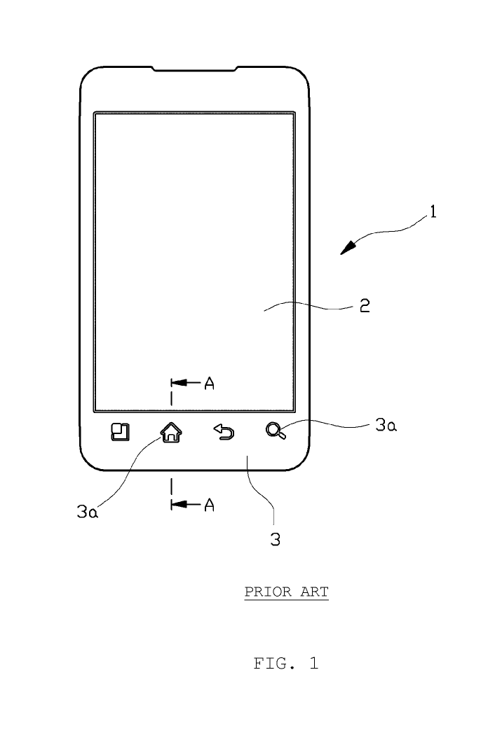

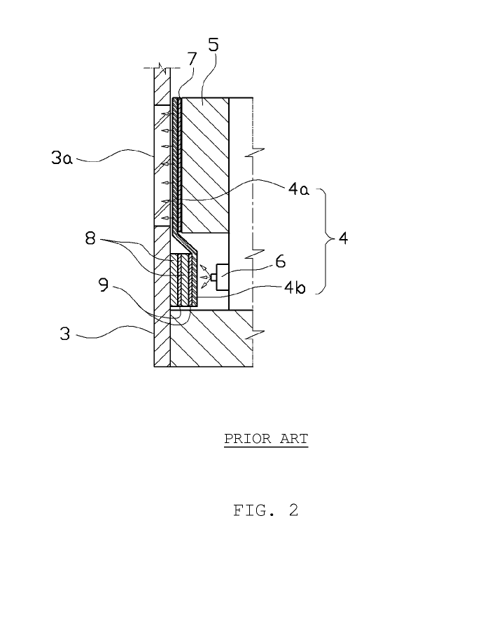

### DETAILED DESCRIPTION OF THE INVENTION

Hereinafter, preferred embodiments of the present invention will be described in detail below with reference to the accompanying drawings.

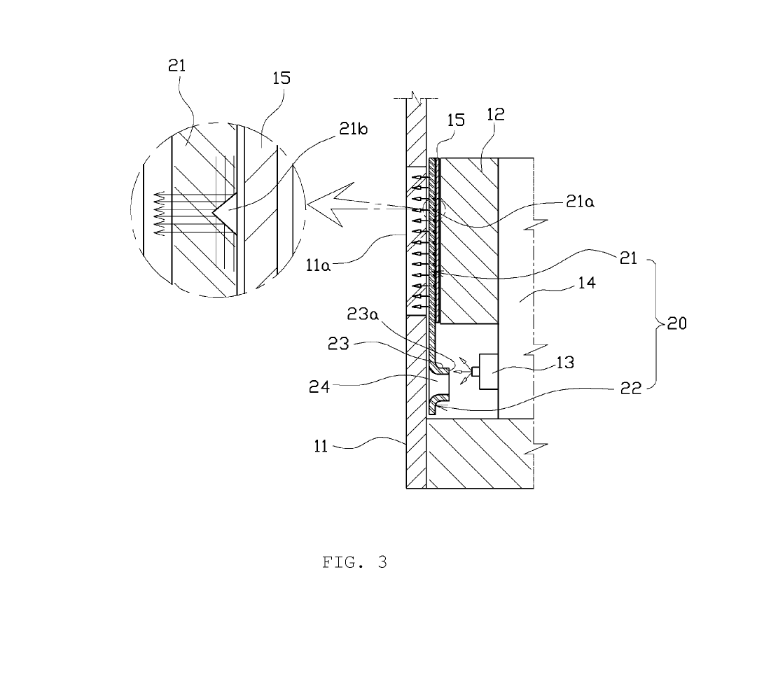

FIG. 3 is a sectional view showing the configuration and installation state of an optical waveguide sheet for a keypad according to a preferred embodiment of the present invention. As shown in FIG. 3, an optical waveguide sheet 20 of the present invention is disposed between a keytop part 11 and a keypad 12 provided for various functions and switching control of portable terminals such as a mobile phone or electronic devices.

The optical waveguide sheet 20 is positioned right below the indicating portion 11a of the keytop part 11, and has a light guiding portion 21 in which a reflective pattern 21a for reflecting the light toward the indicating portion 11a is formed on the bottom, and a light introducing portion 22 positioned above the light source 13 which is mounted on the printed circuit board 14. Accordingly, the light emitted from the light source 13 is guided to the reflective pattern 21a of the light guiding portion 21 through the light introducing portion 22 and is reflected so as to illuminate the indicating portion 11a brightly. At this time, the reflective pattern 21a has a plurality of reflective grooves 21b for reflecting the light, which can be formed in patterns of various shapes. A reflective tape 15 is attached to the bottom of the light guiding portion 21 so as to minimize light loss in the light guiding portion 21.

In addition, the light introducing portion 22 of the optical waveguide sheet 20 of the present invention has a through hole 24 formed therein, and a light introducing flap 23 for efficiently introducing the light emitted from the light source 13. The light introducing flap 23 of a barrel shape is formed along the edge of the through hole 24 provided in the light introducing portion 22. That is, the light introducing flap 23 has a protruded shape extending to the light source 13 from the edge of the through hole 24. The light introducing flap 23 has a light introducing section 23a at a front end of which light is introduced.

The light introducing flap 23 is positioned near to the light guiding portion 21, and it is preferable that the light introducing section 23a, which is part of it, faces the light source 13, or is positioned right above the light source 13.

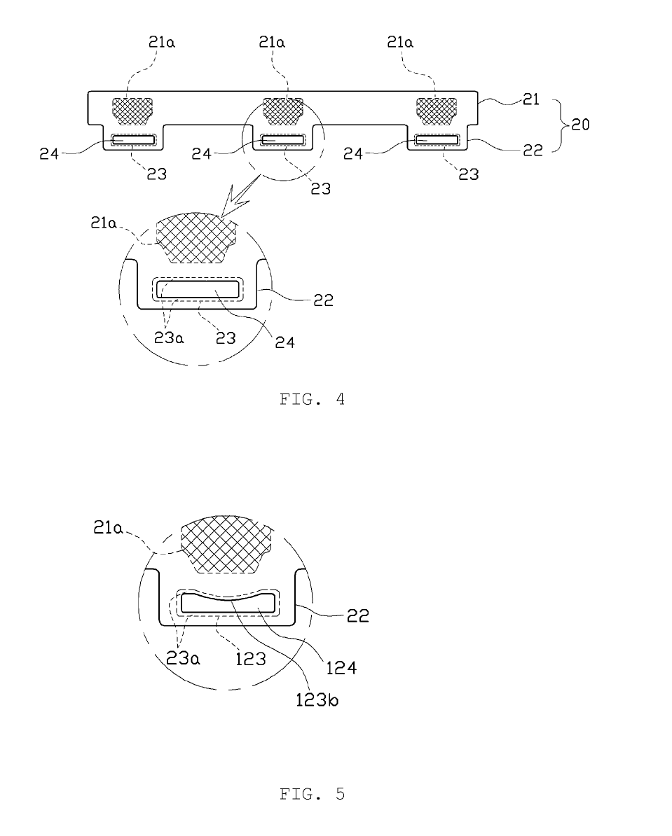

Further, FIG. 5 is a sectional view showing another example of a light introducing flap 123. As shown in FIG. 5, when the through hole 124 has a rectangular cross section, it is preferable to have a curved portion 123b which guides light toward the reflective pattern 21a of the light guiding portion 21 in a concentrated manner. The curved portion 123b is formed on one side wall surface of the light introducing flap 123 positioned near to the light guiding portion 21. At this time, the curved portion 123b is concavely formed inside the through hole 124 opposite to the reflective pattern 21a, so that it is possible to concentrate light toward the reflective pattern 21a.

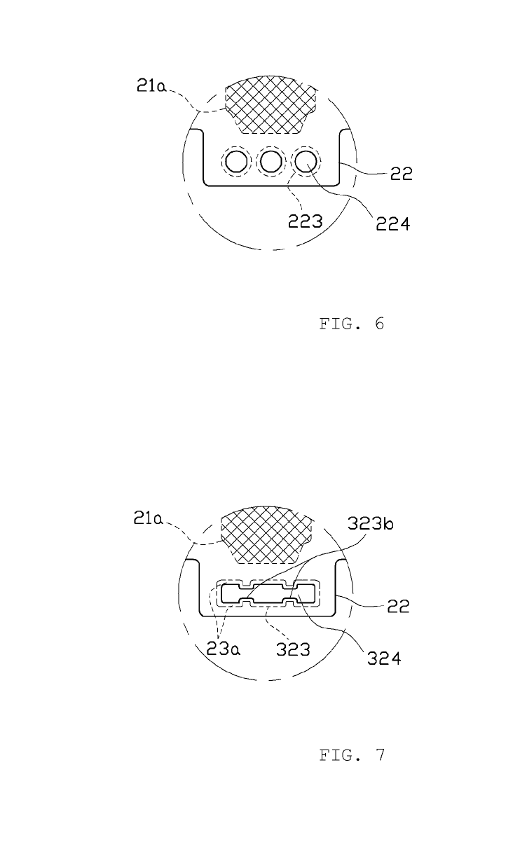

FIG. 6 is a sectional view showing yet another example of the light introducing flap 223. As shown in FIG. 6, it is possible to provide a plurality of circular light introducing flaps 223 by forming the cross section of the through holes 224 in a circular shape. In this case, it is preferable to arrange a plurality of the circular light flaps 223 side by side.

FIG. 7 is a sectional view showing still another example of the light introducing flap 323. As shown in FIG. 7, when the through hole 324 has a rectangular cross section, it is preferable that a plurality of bent portions 323b be formed on the light introducing flap 323. The bent portions 323b reinforce the structure of the light introducing flap 323 to maximally suppress from moving or bending deformation of the light introducing portion 22.

According to the optical waveguide sheet 20 of the present invention with such a configuration, the light emitted from the light source 13 is introduced into the light introducing portion 22 through the light introducing section 23a of the light introducing flap 23 arranged near the light source 13, as shown in FIG. 3 and FIG. 4. At this time, as the light introducing section 23a of the light introducing flap 23 is positioned above the light source 13 and becomes as close as possible to the light source 13, the efficiency for introduction of light can be increased. In particular, a part of the light introducing section 21a of the light introducing flap 23 positioned near to the reflective pattern 21a of the light guiding portion 21 is positioned right above the light source 13 to be disposed so as to face the light source 13, so it is possible to further improve the efficiency for introduction of light by introducing light more effectively.

Further, the through hole 24 formed in the light introducing portion 22 has a rectangular or circular cross section, and the light introducing flap 23 has a rectangular or circular cross section that is integrally connected with the light introducing portion 22 along the edge of the through hole 24, so the structure is sturdy and prevents deformation or moving. Accordingly, the light introducing section 23a of the light introducing flap 23 is positioned such that, even after the assembly of the optical waveguide sheet 20, it is possible to maintain the performance for maximum introduction of light.

As shown in FIG. 5, the through hole 124 formed in the light introducing portion 22 has a rectangular cross section, and the curved portion 123b for guiding light toward the reflective pattern 21a of the light guiding portion 21 is formed on one side wall surface of the light introducing flap 123 positioned toward the light guiding portion 21. By such a configuration, light introduced from the light source 13 can be concentrated and guided toward the reflective pattern 21a of the light guiding portion 21, such that more light can be guided toward the reflective pattern 21a of the light guiding portion 21 to illuminate the indicating portion 11a more brightly.

Further, the light guided from the light introducing portion 22 to the light guiding portion 21 is guided to the indicating portion 11a provided in the keytop part 11 through the reflective pattern 21a, so the indicating portion 11a is illuminated brightly, and more light can be guided to the indicating portion 11a by the reflective tape 15 attached to the bottom of the light guiding portion 21.

While the present invention has been described with reference to the preferred embodiments, it will be understood by those skilled in the related art that various modifications and variations may be made therein without departing from the scope of the present invention as defined by the appended claims.

What is claimed is:

1. An optical waveguide sheet for a keypad having a light guiding portion positioned below an indicating portion of a keytop part, and a light introducing portion positioned above a light source to guide a light emitted from the light source to the light guiding portion so as to be guided toward the indicating portion,
wherein the light introducing portion comprises a through hole formed therein, a light introducing flap of a barrel shape formed around the edge of the through hole so as to connect with the light introducing portion and protrude toward the light source, and a light introducing section provided on an end of the light introducing flap for the light emitted from the light source to be introduced.

2. The optical waveguide sheet of claim 1, wherein a part of the light introducing section provided on the light introducing flap is disposed so as to face the light source.

3. The optical waveguide sheet of claim 1, wherein the through hole has a rectangular or circular cross section.

4. The optical waveguide sheet of claim 1, wherein the light guiding portion is provided with a reflective pattern, the through hole of the light introducing portion has a rectangular cross section, and a curved portion for guiding the light toward the reflective pattern of the light guiding portion is formed on one side wall surface of the light introducing flap positioned near to the light guiding portion.

5. The optical waveguide sheet of claim 1, wherein the light introducing flap includes a plurality of curved portions for structural reinforcing.
